(19) United States
(12) Patent Application Publication
(10) Pub. No.: US 2023/0062808 A1
(43) Pub. Date: Mar. 2, 2023

(54) TANK, IN PARTICULAR FOR HYDROGEN, WITH IMPROVED SEALING

(71) Applicant: FAURECIA SYSTEMES D'ECHAPPEMENT, NANTERRE (FR)

(72) Inventor: Yannick GODARD, BLUSSANS (FR)

(21) Appl. No.: 17/792,430

(22) PCT Filed: Jan. 13, 2021
(86) PCT No.: PCT/EP2021/050546

§ 371 Date: Jul. 13, 2022

(30) Foreign Application Priority Data
Jan. 15, 2020 (FR) FR2000366

(51) Int. Cl. F17C 1/16; B23K 20/06

(52) U.S. Cl. CPC F17C 1/16; B23K 20/06; B23K 2101/12

(57) ABSTRACT

A tank comprises a shell, delimiting a storage enclosure and having at least one opening, and a connection me connected to the at least one opening of the shell. The connection member_-comprises a tubular element, delimiting a duct, and an annular element. The shell comprises a rim delimiting the at least one opening, the rim being radially clamped between the tubular element and the annular element.

### CROSS REFERENCE TO RELATED APPLICATIONS

This application is the US national phase of PCT/EP2021/050546, which was filed on Jan. 13, 2021, which claims priority to FR 20 00366, filed Jan. 15, 2020.

### FIELD OF THE DISCLOSURE

The present disclosure relates to a fluid storage tank, in particular for hydrogen, intended to equip a vehicle, for example, more particularly a motor vehicle.

### BACKGROUND

A tank comprising a shell delimiting a fluid storage enclosure is already known in the state of the art, having at least one opening for filling and/or discharging fluid to or from the enclosure. The fluid can be gas or liquid.

The tank also includes a connection member, fixed to the shell at the opening, making it possible for the tank to connect with a fluid conveying duct. The connection member generally comprises a valve, thus making closure of the enclosure possible.

It should be noted that the sealing between the shell and the connection member is difficult to achieve in some cases. In particular, the shell is generally made of plastic and the connecting member made of metal, which makes their assembly difficult. This may thus result in leaks, and/or require a long and/or complex and/or expensive manufacturing method.

The disclosure aims in particular to remedy this disadvantage by providing a tank whose sealing is ensured in a simple, reliable, and effective manner.

### SUMMARY

The subject disclosure provides a fluid storage tank, in particular of hydrogen, comprising a shell, delimiting a storage enclosure and having at least one opening, and a connection member, connected to the at least one opening of the shell, characterized in that:
the connection member comprises a tubular element, delimiting a duct, and an annular element; and
the shell comprises a rim delimiting the opening, the rim being radially clamped between the tubular element and the annular element.

The particular structure of the connection member according to the disclosure makes magnetic pulse welding possible between the rim of the at least one opening and the tubular element. Such a magnetic pulse welding makes it possible to make a seal in a simple, reliable and efficient way.

A tank according to the disclosure may further comprise one or more of the following features, taken alone or in any technically feasible combinations.

The rim radially surrounds the tubular element.

The annular element is made of a conductive material, in particular of metal for example.

The tubular element is made of a conductive material, in particular of metal for example.

The rim is fixed to the tubular element by magnetic pulse welding.

The connection member comprises a connection element, surrounding the tubular element.

The shell is made of plastic.

The disclosure also relates to a method for manufacturing a fluid storage tank as defined above, comprising:
producing a shell beforehand, having at least one opening, and comprising a rim delimiting the opening;
roviding a tubular element, delimiting a duct, and either inserting the tubular element into the rim or the rim into the tubular element;
roviding an annular element; and
radially clamping, so as to radially clamp the rim between the tubular element and the annular member.

A manufacturing method according to the disclosure may further comprise one or more of the following features, taken alone or in any technically feasible combinations.

The radial clamping is achieved by magnetically pulse welding the rim with the tubular element.

Following the magnetic pulse welding, the manufacturing method comprises placing a connection element, surrounding the tubular element.

### BRIEF DESCRIPTION OF THE DRAWINGS

Various aspects and advantages of the disclosure will be highlighted in the following description, given only by way of example and made with reference to the attached figures, among which:

FIG. 1 partially represents, in an axial section, a tank according to one example embodiment of the disclosure; and

FIGS. 2 and 3 are views similar to FIG. 1, representing the tank of FIG. 1 during two stages of a method for manufacturing this tank.

### DETAILED DESCRIPTION

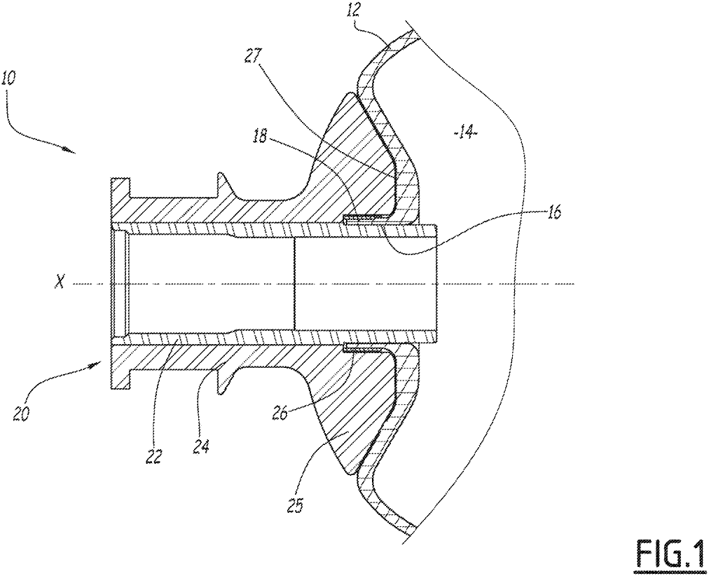

Shown in FIG. 1 is a fluid storage tank 10 according to one example embodiment of the disclosure. In the example described, the fluid stored is hydrogen, in a liquid or gaseous form, depending on the desired application.

The storage tank 10 comprises a shell 12, delimiting a fluid storage enclosure 14. The shell 12 has a general shape of revolution about a longitudinal axis, for example. In a conventional manner, the shell 12 is made of a plastic material, for example.

The shell 12 has at least one opening 16, forming a passage for filling the fluid into the enclosure 14 and/or for discharging the fluid from the enclosure 14.

At the opening 16, the shell 12 has a rim 18, extending circumferentially about an axis X. The axis X is coincident with the longitudinal axis of the shell 12, for example. This rim 18 radially delimits said opening 16.

The rim 18 preferably extends outward of the enclosure 14. In a variant, the rim 18 may extend inward of the enclosure 14.

The tank 10 further includes a connection member 20, connected to the shell 12, as will be described below.

The connection member 20 according to the disclosure is formed in several parts, and in particular comprises a tubular element 22 and a connection element 24.

As shown in FIG. 1, the tubular element 22 has a general shape of revolution about the X axis. The tubular element 22 partially extends into the opening 16, with the rim 18 radially surrounding this tubular element 22. The rim 18 is fixed to the tubular element 22 by magnetic pulse welding, as will be described later.

The connection element 24 also has a general shape of revolution about the X axis. The connection element 24 is radially arranged about the tubular element 22. The connection element 24 is fixed to the tubular element 22 by any conceivable manner, such as by interlocking.

The tubular element 22 internally delimits a duct, in fluid communication with the enclosure 14 through the opening 16. The connection element 24 has a conventional external shape making connection to a duct provided for this purpose possible, in a manner known per se.

It should be noted that the connection element 24 comprises a base 25 covering the rim 18 in particular, the base 25 being inserted in a complementary recess 27 formed by the shell 12.

The tubular element 22 is made of a conductive material, preferably made of a metallic material, for example aluminum or stainless steel. The connection element 24 is also preferably made of a metallic material, such as aluminum or stainless steel.

Finally, the tank 10 comprises an annular element 26, radially surrounding the rim 18.

The annular element 26 is made of a conductive material, preferably made of metallic material, such as steel, stainless steel, aluminum or copper.

Preferably, the annular element 26 is made of aluminum, to avoid galvanic corrosion problems. In addition, aluminum is more easily formed than steel.

Galvanic corrosion problems can also be avoided by providing sufficient insulation and/or space between the annular element 26 and the connection element 24.

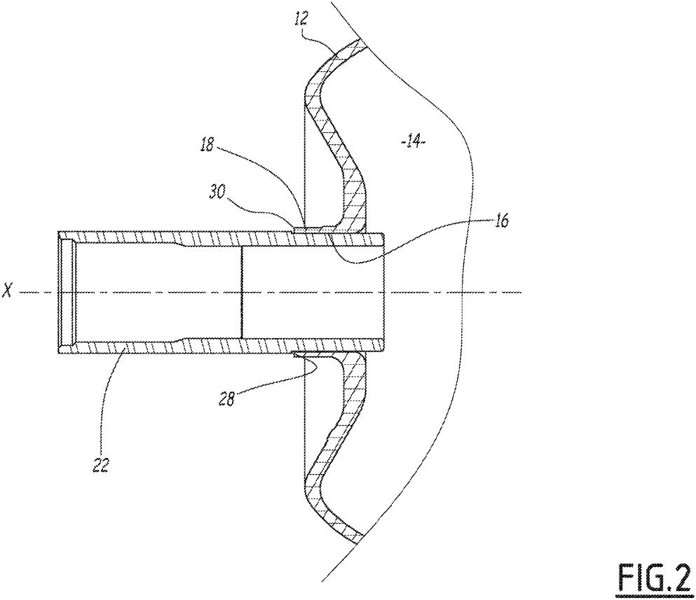

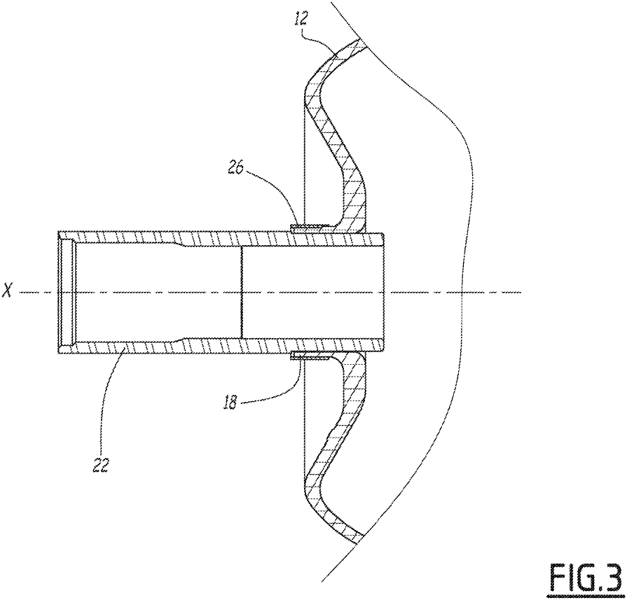

The annular element 26 is used to conduct the magnetic pulse welding of the rim 18 with the tubular element 22, such that the rim 18 is radially clamped between the tubular element 22 and the annular element 26, in a manufacturing method that will now be described with reference to FIGS. 2 and 3.

The manufacturing method comprises the production beforehand of the shell 12, having at least the opening 16 and the rim 18 delimiting the opening 16. The shell 12 is made by molding, for example.

The method then comprises providing the tubular element 22, and inserting this tubular element 22 into the opening 16, so that the rim 18 radially surrounds the tubular element 22. It should be noted that the tubular element 22 preferably comprises a shoulder 28 on its outer surface, this shoulder 28 being intended to abut an end 30 of the rim 18 in order to limit the insertion of the tubular element 22 into the opening 16.

The manufacturing method then comprises inserting the annular element 26 around the rim 18, as shown in FIG. 3. In the described embodiment, this insertion is possible due to the fact that the diameter of this annular element 26 is larger than the diameter of the tubular element 22.

This annular element 26 makes it possible to conduct the magnetic pulse welding of the tubular element 22 with the rim 18.

The magnetic pulse welding is conducted by subjecting the assembly formed by the tubular element 22, the rim 18, and the annular element 16 to a high amplitude magnetic field. This magnetic field is highly variable over time, so that it generates induced currents (eddy currents) in the annular element 26.

The interaction between the magnetic field and the induced currents in the annular element 26 generates strong forces of magnetic origin, which act mechanically on the annular element 26. These magnetic forces transform the magnetic energy into mechanical energy, acting radially on the annular element 26, very abruptly. The annular element 26 then retracts sharply, so that the rim 18 becomes clamped between this annular element 26 and the tubular element 22.

The fastening by magnetic pulse welding is remarkable in that the rim 18 is clamped very tightly between the annular element 26 and the tubular element 22, without melting of material or presence of any binder. It is therefore easy to determine when these elements are actually fixed by magnetic pulse welding in accordance with the disclosure.

Following magnetic pulse welding, the connection element 24 is placed around the tubular element 22, by interlocking, for example, to arrive at the tank as shown in FIG. 1.

It will be noted that the disclosure makes it possible to join two elements made of different materials in a manner strong enough to provide optimal sealing, without the need for a gasket.

It will be noted that the disclosure is not limited to the previously described embodiment, but may have diverse variants.

For example, the tubular element 22 could radially surround the rim 18, in which case the annular element 26 would be arranged within the rim 18.

In another embodiment, the connection element 24 could be overmolded onto the tubular member, after magnetic pulse welding.

Although various embodiments have been disclosed, a worker of ordinary skill in this art would recognize that certain modifications would come within the scope of this disclosure. For that reason, the following claims should be studied to determine the true scope and content of this disclosure.

1. A fluid storage tank, comprising a shell delimiting a storage enclosure and having at least one opening , and a connection member connected to the at least one opening of the shell (12), wherein:
the connection member comprises a tubular element, delimiting a duct, and an annular element; and
the shell comprises a rim delimiting the at least one opening, the rim being radially clamped between the tubular element and the annular element.

2. The fluid storage tank according to claim 1, wherein the rim radially surrounds the tubular element.

3. The fluid storage tank according to claim 1, wherein the annular element is made of a conductive material .

4. The fluid storage tank according to claim 1, wherein the tubular element is made of a conductive material .

5. The fluid storage tank according to claim 1, wherein the rim is fixed to the tubular element by magnetic pulse welding.

6. The fluid storage tank according to claim 1, wherein the connection member comprises a connection element surrounding the tubular element.

7. The fluid storage tank according to claim 1, wherein the shell is made of plastic.

8. A method of manufacturing the fluid storage tank according to claim 1, comprising:
producing the shell, beforehand, having the at least one opening and comprising the rim delimiting the at least one opening;
providing the tubular element, delimiting the duct, and either inserting the tubular element into the rim or the rim into the tubular element;
providing the annular element; and
radially clamping, so as to radially clamp the rim between the tubular element and the annular member.

9. The manufacturing method according to claim 8, wherein the-radial clamping is achieved by magnetically pulse welding the rim to the tubular element.

10. The manufacturing method according to claim 8, comprising placing a connection element, following the magnetic pulse welding, that surrounds the tubular element.

11. The fluid storage tank according to claim 3, wherein the annular element is made of metal.

12. The fluid storage tank according to claim 4, wherein the tubular element is made of metal.
